(19) United States
(12) Patent Application Publication
(10) Pub. No.: US 2010/0321730 A1
(43) Pub. Date: Dec. 23, 2010

(54) JOB PROCESSING APPARATUS, CONTROL METHOD OF JOB PROCESSING APPARATUS, AND STORAGE MEDIUM

(75) Inventor: Hideyasu Tomi, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/814,351

(22) Filed: Jun. 11, 2010

(30) Foreign Application Priority Data
Jun. 19, 2009 (JP) 2009-146383

(51) Int. Cl. G06F 3/12

(52) U.S. Cl. 358/1.15

(57) ABSTRACT

It enables to cancel a job transferred from a communication apparatus to a job processing apparatus, even if a user does not perform a complicated operation. To achieve this, there is provided a control method for controlling the job processing apparatus for establishing a communication session with the communication apparatus and communicating with the communication apparatus by the established communication session, the control method comprising: receiving plural images from the communication apparatus by the communication session; holding, in a holding unit, the received plural images as the plural jobs to be processed; and controlling to, in a case where the communication session with the communication apparatus is disconnected while the reception of the plural images is not completed, cancel, among the jobs held in the holding unit, the job corresponding to the image which has been received from the communication apparatus by the communication session.

### BACKGROUND OF THE INVENTION

1. Field of the Invention

The present invention relates to a job processing apparatus, a control method of the job processing apparatus, and a storage medium for storing a program to cause a computer to perform the control method of the job processing apparatus.

2. Description of the Related Art

Conventionally, in case of canceling a job which was input to a job processing apparatus such as a printing apparatus, a user has to perform a predetermined operation through an operation unit of the printing apparatus. More specifically, the user first displays a list of the jobs which are currently stored in the printing apparatus and which are being performed and/or wait to be performed, selects from the list of the displayed jobs the job to be canceled, and then instructs to cancel the selected job.

Further, as a method of transferring image data between apparatuses, there has been conceived a method as disclosed in, e.g., Japanese Patent Application Laid-Open No. 2008-099236 of performing wireless communication at high speed between the apparatuses respectively positioned at short range. Therefore, in a case where such a mechanism is applied to a data processing apparatus such as a digital cameral or the like, if the data processing apparatus is approximated to the vicinity of a communication unit provided in a job processing apparatus, it is possible to transfer the data stored in the data processing apparatus to the job processing apparatus without complicated setting.

In a case where such a conventional technique is used, for example, it is conceivable that image data stored in the data processing apparatus is transferred to the job processing apparatus as a job to be processed by the job processing apparatus. More specifically, if it is assumed that the job processing apparatus is a printing apparatus and the data processing apparatus is a digital camera, it is conceivable that the image data stored in a memory of the digital camera is transferred to the printing apparatus and then the transferred image data is printed by the printing apparatus as a print job. In this case, it is conceivable that the printing apparatus receives the plural image data from the data processing apparatus, holds the received plural image data as the plural jobs, and then performs the held jobs in order of reception.

However, in a case where it is necessary to cancel the job transferred to the job processing apparatus, it is impossible to quickly cancel the transferred job if the conventional canceling method as described above is used.

### SUMMARY OF THE INVENTION

The present invention has been completed in consideration of such a conventional problem as described above, and aims to provide a job processing apparatus for establishing a communication session with a communication apparatus and communicating with the communication apparatus by the established communication session, comprising: a receiving unit configured to receive plural images from the communication apparatus by the communication session; a holding unit configured to hold the plural images received by the receiving unit, as plural jobs to be processed; and a control unit configured to, in a case where the communication session with the communication apparatus is disconnected while the reception of the plural images is not completed, cancel, among the jobs held in the holding unit, the job corresponding to the image which has been received from the communication apparatus by the communication session.

Further features of the present invention will become apparent from the following description of exemplary embodiments with reference to the attached drawings.

### BRIEF DESCRIPTION OF THE DRAWINGS

FIG. 1 is an outline diagram illustrating an example of a job processing apparatus.

FIG. 2 is a block diagram illustrating an example of an image forming system including an image forming apparatus.

FIG. 3 is a block diagram for describing a constitution of a controller unit.

FIG. 4 is a two-dimensional diagram for describing a configuration of an operation unit.

FIG. 5 is a diagram illustrating an example of a user interface displayed on a touch panel section.

FIG. 6 is a block diagram for describing a constitution of a communication apparatus.

FIG. 7 is a diagram illustrating a data communication procedure of the communication apparatus and the image forming apparatus.

FIG. 8 is a diagram illustrating an example of job information to be transmitted from the communication apparatus to the image forming apparatus.

FIG. 9 is a flow chart indicating a job processing procedure of the image forming apparatus.

FIG. 10 is a diagram illustrating a management table indicating a job situation of the image forming apparatus.

FIG. 11 is a diagram illustrating a management table indicating a job situation of the image forming apparatus.

FIG. 12 is a cross section diagram for describing a constitution of a weight detection unit provided in the image forming apparatus.

FIG. 13 is a diagram illustrating a data communication procedure of the communication apparatus and the image forming apparatus.

FIG. 14 is a diagram for describing a structure of transfer data to be transferred from the communication apparatus.

FIG. 15 is a flow chart indicating a job processing procedure of the image forming apparatus.

FIG. 16 is a diagram illustrating a management table indicating a job situation of the image forming apparatus.

FIG. 17 is a block diagram for describing a constitution of a second wireless communication unit of the image forming apparatus.

FIG. 18 is a flow chart indicating a job processing procedure of the image forming apparatus.

### DESCRIPTION OF THE EMBODIMENTS

Preferred embodiments of the present invention will now be described in detail with reference to the accompanying drawings.

### First Embodiment

Hereinafter, the embodiment of the present invention will be described with reference to the attached drawings.

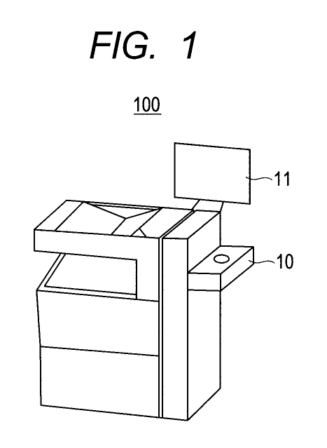

FIG. 1 is an outline diagram illustrating an image forming apparatus which is an example of a job processing apparatus according to the present embodiment. In the present embodiment, an image forming apparatus 100 such as an MFP (multi function peripheral) which has plural functions is described as an example of the job processing apparatus. Incidentally, the job processing apparatus will be described by taking the MFP for example. However, the job processing apparatus may be a copying machine which has only a copy function or an SFP (single function peripheral) which has only a printer function.

In FIG. 1, the image forming apparatus 100 includes a communication unit 10 and a display unit 11. Here, the communication unit 10 is used to perform wireless communication with communication apparatuses which include a digital camera, a mobile phone, a PDA (personal digital assistant), a notebook-sized personal computer and the like. That is, it is assumed that each of the digital camera, the mobile phone, the PDA, the notebook-sized personal computer and the like has a wireless communication function.

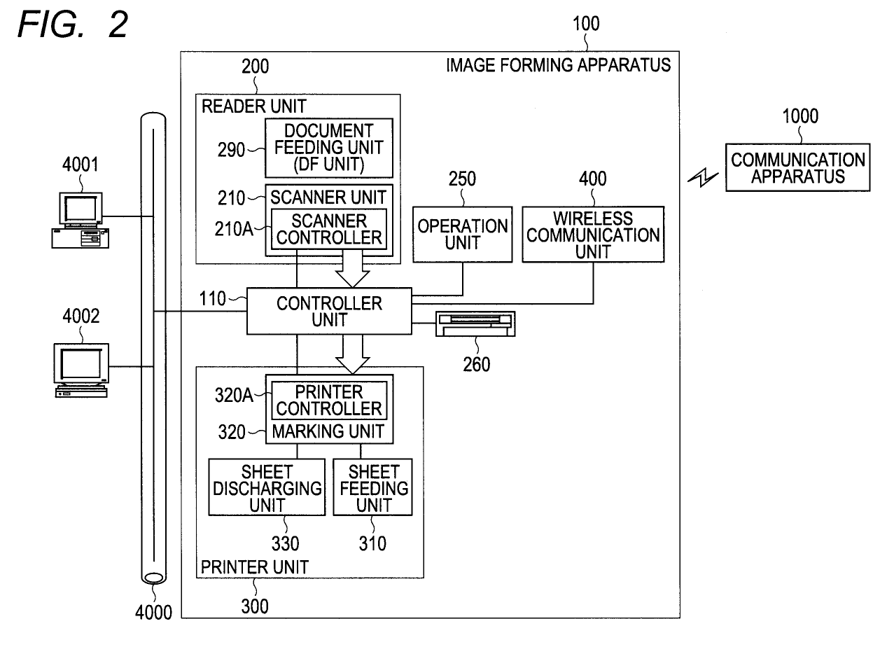

A user can perform communication between the image forming apparatus 100 and a communication apparatus 1000 (FIG. 2) by approximating and/or putting the communication apparatus 1000 having an image input function to/on the communication unit 10. Thus, the image forming apparatus 100 is constituted to be able to perform high-speed wireless communication with the communication apparatus 1000.

The display unit 11, which is constituted by a touch panel and a liquid crystal display unit, displays an operation screen to accept instructions from the user. Further, the display unit 11 displays a state of the image forming apparatus 100.

FIG. 2 is a block diagram illustrating an example of an image forming system which includes the image forming apparatus 100 illustrated in FIG. 1. Hereinafter, the image forming system which is configured by the image forming apparatus 100 and the communication apparatus 1000 will be described with reference to FIG. 2.

In FIG. 2, a controller unit 110 is electrically connected to a reader unit 200 and a printer unit 300. Thus, the controller unit 110 receives information from the reader unit 200 and the printer unit 300, and transmits various commands to the reader unit 200 or the printer unit 300. Also, the controller unit 110 is connected to PCs (personal computers) 4001 and 4002 through a network 4000 such as a LAN (local area network). Thus, the controller unit 110 receives image data and control commands from the PC 4001 and the PC 4002 through the network 4000. Here, for example, Ethernet™ is used as the network.

The reader unit 200 optically reads an original image, and converts the read original image into image data. In any case, the reader unit 200 is constituted by a scanner unit 210 having a function to read the original image and a document feeding (DF) unit 290 for feeding and transporting an original document to the position at which the scanner unit 210 can read the original image of the original document.

A scanner controller 210A controls the DF unit 290 and the scanner unit 210, on the basis of an instruction transferred from the controller unit 110.

The printer unit 300 is constituted by a sheet feeding unit 310 which holds therein sheets for printing, a marking unit 320 which transfers and fixes the image data to the sheet, and a sheet discharging unit 330 which discharges the sheet on which the image data has been printed. In the printer unit 300, a printer controller 320A receives an instruction transferred from the controller unit 110, and then the printer controller 320A causes the sheet feeding unit 310 to feed the sheet on the basis of the received instruction. Subsequently, the printer controller 320A controls to print the image data on the fed sheet, and to discharge the sheet on which the image data has been printed to the sheet discharging unit 330.

Incidentally, the sheet feeding unit 310 can hold therein plural kinds of sheets. Further, the sheet discharging unit 330 can perform sorting and/or stapling to the sheets on which the image data have been printed respectively.

An operation unit 250, which corresponds to the display unit 11 illustrated in FIG. 1, is constituted by, for example, hardware keys, a liquid crystal display section, and a touch panel section which is applied on the liquid crystal display section. Thus, the operation unit 250 receives user's instructions through the hardware keys, the liquid crystal display section and/or the touch panel section.

The operation unit 250 transfers to the controller unit 110 a command corresponding to the instruction accepted from the user, and the controller unit 110 performs control according to the received command. Further, the operation unit 250 causes the liquid crystal display unit to display software keys for accepting the operations of the image forming apparatus 100, and the functions and states of the image forming apparatus 100.

An HDD (hard disk drive) 260 stores therein various settings of the image forming apparatus 100, and various data. Further, the HDD 260 functions as a holding unit which holds the image data as the job.

The image forming apparatus 100 performs, for example, a copy function, an image data transmission function, a printer function and the like by using such constituent elements as described above. More specifically, in case of performing the copy function, the controller unit 110 causes the reader unit 200 to read the image data from the original document, and causes the printer unit 300 to print the read image data to the sheet. In case of performing the image data transfer function, the controller unit 110 converts the image data read by the reader unit 200 into code data, and transmits the converted code data to the PC 4001 and/or the PC 4002 through the network 4000. In case of performing the printer function, the controller unit 110 analyzes and extracts code data received from the PC 4001 and/or the PC 4002 through the network 4000, converts the obtained code data into the image data, and outputs the converted image data to the printer unit 300. Then, the printer unit 300 performs printing based on the image data received from the controller unit 110.

A wireless communication unit 400, which is provided in the communication unit 10 illustrated in FIG. 1, detects that the communication apparatus 1000 is approximated to the communication unit 10, and thus transmits/receives control data, image data and the like to/from the approximated communication apparatus 1000. The wireless communication unit 400 may be controlled based on an instruction from the controller unit 110. Alternatively, the wireless communication unit 400 may uniquely contain a CPU (central processing unit) so that the wireless communication unit is controlled by the CPU.

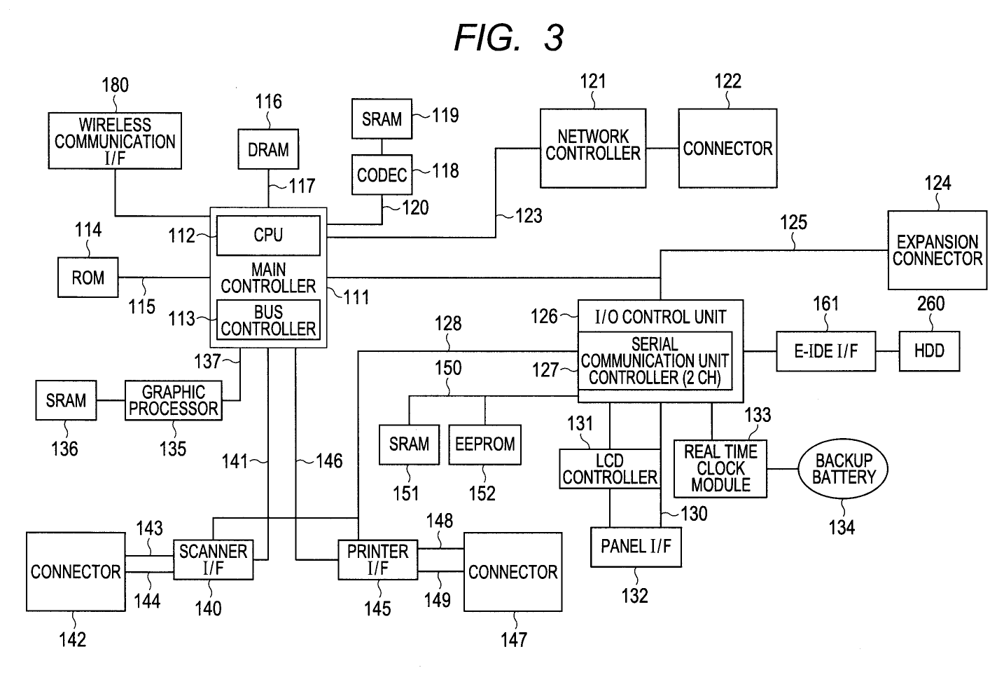

FIG. 3 is a block diagram for describing a constitution of the controller unit 110 illustrated in FIG. 2. In FIG. 3, a main controller 111 is principally constituted by a CPU 112, a bus controller 113 and various I/F (interface) controller circuits. The CPU 112 and the bus controller 113 totally control the whole operation of the controller unit 110. The CPU 112 performs various operations based on programs read from an ROM (read only memory) 114 through an ROM I/F 115. More specifically, the CPU 112 interprets the code data (e.g., PDL (page description language) data) received from the PC 4001 or the PC 4002 illustrated in FIG. 1, and controls storage operations of memories such as a DRAM (dynamic random access memory) 116, the HDD 260 and the like. Further, the CPU 112 controls various jobs of the image forming apparatus 100, and stops the job in response to a stop instruction.

The bus controller 113 controls transfer operations of data input/output to/from each I/F. More specifically, the bus controller 113 adjusts the buses, and controls a DMA (direct memory access) data transfer operation. The DRAM 116, which is connected to the main controller 111 through a DRAM I/F 117, is used as a working area for the CPU 112 and/or an area for storing the image data. Further, the DRAM 116 stores a communication start time and a communication session for the image forming apparatus 100.

A codec 118 compresses raster image data stored in the DRAM 116 according to various coding methods such as an MH (Modified Huffman) method, an MR (Modified READ (Relative Element Address Designate)) method, an MMR (Modified Moddified READ) method, a JBIG (Joint Bi-level Image experts Group) method, a JPEG (Joint Photographic Experts Group) method, and the like. On the other hand, the codec 118 extracts the code data stored in the compressed state into the raster image data. An SRAM (static random access memory) 119 is used as a temporary working area for the codec 118. The codec 118 is connected to the main controller 111 through an I/F 120. The data transfer between the codec 118 and the DRAM 116 is performed in the form of DMA data transfer under the control of the bus controller 113.

A graphic processor 135 performs various processes such as an image rotation process, an image magnification changing process, a color space conversion process, a binarizing process and the like to the raster image data stored in the DRAM 116. An SRAM 136 is used as a temporary working area for the graphic processor 135. The graphic processor 135 is connected to the main controller 111 through an I/F 137. The data transfer between the graphic processor 135 and the DRAM 116 is performed in the form of DMA data transfer under the control of the bus controller 113. A network controller 121 is connected to the main controller 111 through an I/F 123, and is further connected to an external network such as the network 4000 by means of a connector 122.

An expansion connector 124 for connecting an expansion board and an I/O (input/output) control unit 126 are connected to a general-purpose high-speed bus 125. For example, a PCI (peripheral component interconnect) bus is used as the general-purpose high-speed bus 125. Incidentally, the I/O control unit 126 is equipped with a serial communication unit controller 127 (two channels) of a start-stop synchronous communication type for transmitting/receiving the control commands to/from the CPU of each of the reader unit 200 and the printer unit 300. Here, the I/O control unit 126 is connected to a scanner I/F 140 and a printer I/F 145 through an I/O bus 128.

A panel I/F 132 transmits/receives the data to/from the operation unit 250 illustrated in FIG. 1, and transfers the image data from an LCD (liquid crystal display) controller 131 to the operation unit 250. Further, the panel I/F 132 transfers a key input signal accepted through the key such as the hardware key, the liquid crystal touch panel key or the like provided on the operation unit 250 to the I/O control unit 126 through a key input I/F 130. A real time clock module 133 updates/stores the date and the time to be managed in the image forming apparatus 100, and power is supplied to the real time clock module 133 by a backup battery 134.

An E-IDE (Enhanced Integrated Drive Electronics) I/F 161 is used to connect the HDD 260. The CPU 112 stores/reads the image data in/from the HDD 260 through the E-IDE I/F 161. A connector 142, which is connected to the reader unit 200, is constituted by a start-stop synchronous communication serial I/F 143 and a video I/F 144, and a connector 147, which is connected to the printer unit 300, is constituted by a start-stop synchronous communication serial I/F 148 and a video I/F 149.

The scanner I/F 140, which is connected to the reader unit 200 through the connector 142, is also connected to the main controller 111 through a scanner bus 141. The scanner I/F 140 performs a predetermined process to the image data received from the reader unit 200. Further, the scanner I/F 140 outputs, to the scanner bus 141, a control signal generated based on a video control signal sent from the reader unit 200. Here, the data transfer from the scanner bus 141 to the DRAM 116 is controlled by the bus controller 113.

The printer I/F 145, which is connected to the printer unit 300 through the connector 147, is also connected to the main controller 111 through a scanner bus 146. The scanner I/F 145 performs a predetermined process to the image data output from the main controller 111, and outputs the processed image data to the printer unit 300. Further, the transfer of the raster image data extracted on the DRAM 116 to the printer unit is performed under the control of the bus controller 113. Thus, the raster image data extracted on the DRAM 116 is DMA transferred through the printer bus 146, the printer I/F 145 and the video I/F 149.

An SRAM 151 is a memory which can hold the stored contents even if the power supplied from the backup battery to the whole of the image forming apparatus 100 is interrupted. The SRAM 151 is connected to the I/O control unit 126 through a bus 150. Also, an EEPROM (electrically erasable and programmable read only memory) 152 is connected to the I/O control unit 126 through the bus 150.

A wireless communication I/F 180 transmits/receives the data to/from the wireless communication unit 400 illustrated in FIG. 2, and the CPU 112 causes to receive the data from the wireless communication unit 400 through the wireless communication I/F 180. Besides, the CPU 112 causes to transfer the data to the wireless communication unit 400 through the wireless communication I/F 180.

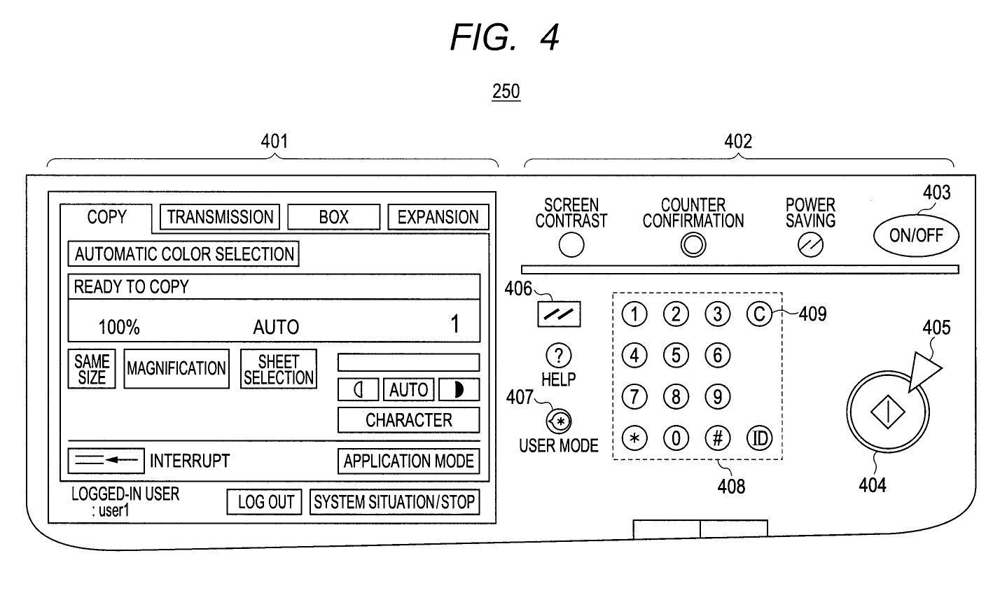

FIG. 4 is a two-dimensional diagram for describing a configuration of the operation unit 250 illustrated in FIG. 2. Namely, in the present embodiment, the operation unit 250 consists of a touch panel section 401 and a key input section 402. In FIG. 4, the touch panel section 401 includes an LCD, and a touch panel display which is applied on the LCD and composed of transparent electrodes. Further, the touch panel section 401 has a function to accept various settings from the user, and a function to present information to the user. For example, if it is detected that the portion corresponding to the display key displayed on the LCD is depressed by the user, the CPU 112 performs the process according to the depressed display key. Incidentally, an example to be displayed on the screen of the touch panel section 401 will be described later.

The key input section 402 includes an operation unit power on/off switch 403. Here, if the operation unit power on/off switch 403 is depressed by the user, the CPU 112 selectively switches an operation mode between a standby mode (setting a normal operation state) and a sleep mode (setting a power saving state). The CPU 112 accepts the user's operation performed to the operation unit power on/off switch 403 in a state that a main power on/off switch (not illustrated) for supplying power to the whole of the system is on. A start key 404 acts as a key which is used in case of accepting, from the user, an instruction for causing the CPU 112 of the image forming apparatus 100 to perform as a print job a series of operations such as the original reading operation of the reader unit 200, a print process of the read original documents, and the like. Further, the start key 404 acts as a key which is used in case of accepting, from the user, an instruction for causing the CPU 112 to exteriorly transmit the image data stored in the HDD 260 through a network I/F. Furthermore, the start key 404 acts as a key which is used in case of accepting, from the user, an instruction for causing the CPU 112 of the image forming apparatus 100 to perform a data transmission job.

A stop key 405 acts as a key for accepting from the user an instruction to stop the process of the accepted print job, and a reset key 406 acts as a key for accepting from the user an instruction to disable various settings made by the user and return the set values to default states. A user mode key 407 acts as a key for causing the touch panel section 401 to display the screen for performing a system setting for each user, numeric keys 408 act as a key for allowing the user to set numerals necessary for the various settings, and a clear key 409 acts as a key for deleting the input values such as a user ID, a password and the like input by the user through the numeric keys 408.

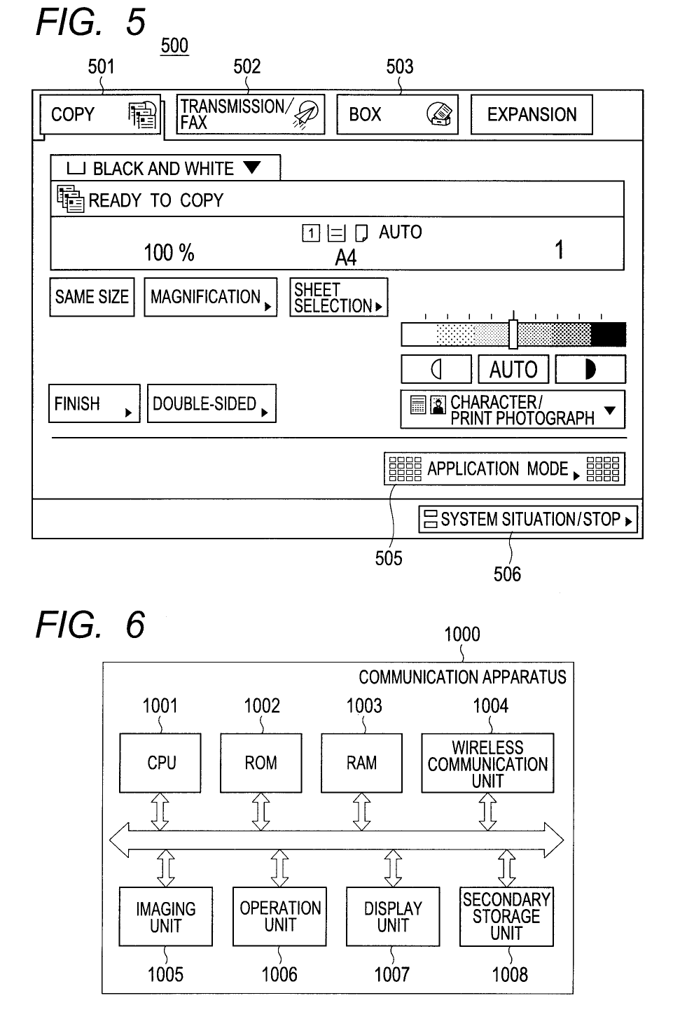

FIG. 5 is a diagram illustrating an example of a user interface to be displayed on the touch panel section 401 illustrated in FIG. 4. In the present embodiment, an example of a job setting screen 500 to be displayed on the touch panel section 401 will be described. More specifically, FIG. 5 indicates the example of the setting screen to be displayed as a standard screen on the touch panel section 401 when the power of the image forming apparatus 100 is turned on.

In FIG. 5, if a copy key 501 is depressed, the CPU 112 displays on the touch panel section 401 a copy job setting screen for performing settings concerning a copy job. The screen illustrated in FIG. 5 is the example of the copy job setting screen for performing the settings concerning the copy job. The CPU 112 accepts, from the user, the settings of print conditions such as the number of prints, a print sheet, a print magnification and the like through the copy job setting screen. Then, if the start key 404 is depressed in the state that the settings of the print conditions have been accepted, the CPU 112 causes the scanner unit to read the original document, and causes the printer unit to perform the printing according the set print conditions.

If a transmission/fax key 502 is depressed, the CPU 112 displays on the touch panel section 401 a data transmission job setting screen for performing the image data transmission function of the image forming apparatus 100 and/or the settings concerning a facsimile function. If a box key 503 is depressed, the CPU 112 displays on the touch panel section 401 a box function setting screen for performing the setting concerning a box function of the image forming apparatus 100.

Here, it should be noted that the box function is a function to store, as files, the image data read by the scanner and/or the image data received externally in a storage area called a box in the HDD 260, and transmit and print the image data in the box in response to the user's instruction under the control of the CPU 112. In the present embodiment, since the HDD 260 has the plural boxes, the user can designate the specific box from the plural boxes to store the image data. Incidentally, an application mode key 505 acts as a key for setting an application mode, and a system situation/stop key 506 acts as a key for displaying a system situation.

FIG. 6 is a block diagram for describing a constitution of the communication apparatus 1000 illustrated in FIG. 1. In the present embodiment, for example, the digital camera having the image input function is used as the communication apparatus 1000, but another device having the image input function can be used instead. The communication apparatus 1000 is constituted by a CPU 1001, an ROM 1002, an RAM (random access memory) 1003, a wireless communication unit 1004, an imaging unit 1005, an operation unit 1006, a display unit 1007 and a secondary storage unit 1008. Here, it should be noted that these constituent units are mutually connected through buses, as illustrated in FIG. 6.

In FIG. 6, the CPU 1001 operates according to a program stored in the ROM 1002 to control various operations of the communication apparatus 1000. Here, the ROM 1002 is a non-volatile memory which stores therein the programs to be performed by the CPU 1001. The RAM 1003 functions as a working memory for the CPU 1001. Further, the RAM 1003 temporarily stores the image data output from the imaging unit 1005 and/or the image data read from the secondary storage unit 1008.

The wireless communication unit 1004, which is constituted by an encoding/decoding circuit unit, an antenna and the like necessary for wireless communication, communicates with an external apparatus which is located within a range of capable of communicating with the wireless communication unit 1004. The imaging unit 1005 is constituted by a lens for imaging incident light, a photoelectric converter (a CCD (charge coupled device), a CMOS (complementary metal-oxide semiconductor) sensor or the like) for converting the imaged light into an electrical signal, an AD (analog-to-digital) converter for converting the analog electrical signal output from the photoelectric converter into a digital electrical signal, and the like. The CPU 1001 generates the image data based on the digital electrical signal converted by the imaging unit 1005, adds setting data such as an image data photographed date, a photographing condition and the like to the generated image data as header information, and stores these data as one file in the secondary storage unit 1008.

The operation unit 1006 is configured by a release button for instructing a photographing operation, a mode selection dial for selecting an operation mode of the digital camera, a menu button for calling a desired menu item, a cross cursor button for selecting and indicating the menu item, other buttons, other dials, other switches, and the like. Here, the states and the state changes of these buttons, dials and switches are output as the electrical signals to the CPU 1001. Thus, the CPU 1001 performs various controls according to such instructions.

The display unit 1007, which is constituted by a liquid crystal display unit, displays the operation screen, the image data of the photographed image, and the like. The secondary storage unit 1008 stores the image data of the photographed images, and the like as the files. Incidentally, the secondary storage unit 1008 may be a built-in non-volatile memory. Alternatively, the secondary storage unit 1008 may be a detachable memory card such as an SD (secure digital) memory card. Here, it is assumed that power is supplied to the secondary storage unit 1008 by not-illustrated power supply equipment such as a battery or the like.

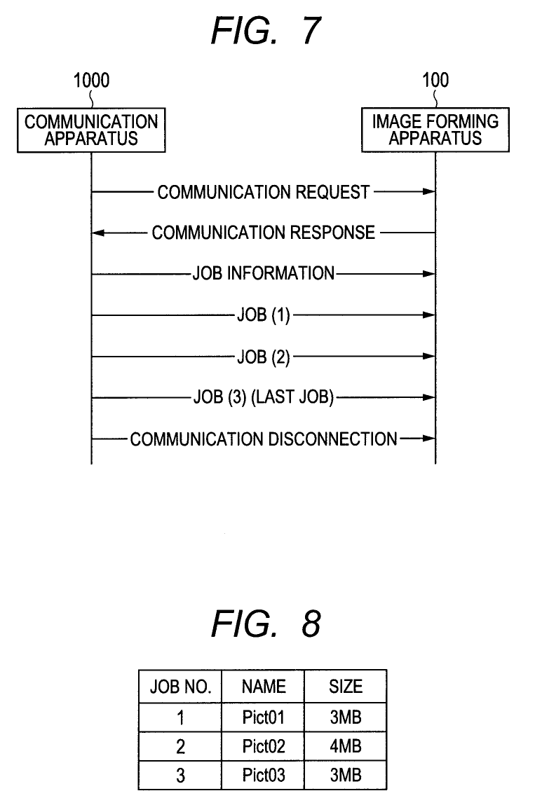

FIG. 7 is a diagram illustrating a data communication procedure of the communication apparatus 1000 and the image forming apparatus 100 according to the present embodiment. In FIG. 7, first, if the user approximates the communication apparatus 1000 to the wireless communication unit 400 (the communication unit 10) of the image forming apparatus, the wireless communication unit 1004 of the communication apparatus 1000 detects a radio wave transmitted from the wireless communication unit 400 of the image forming apparatus 100. Thus, the wireless communication unit 1004 detects that the communication apparatus 1000 has been approximated to the wireless communication unit 400. Then, if it is detected that the communication apparatus 1000 has been approximated to the wireless communication unit 400 of the image forming apparatus, the CPU 1001 of the communication apparatus 1000 instructs the wireless communication unit 1004 to transmit a communication request. Subsequently, the wireless communication unit 400 of the image forming apparatus 100 receives the communication request transmitted from the wireless communication unit 1004, and returns a communication response. Incidentally, although the wireless communication unit 400 returns the communication response in the present embodiment, the CPU 112 may receive the communication request from the wireless communication unit 400 through the wireless communication I/F 180, and then return the communication response.

The CPU 1001, which received the communication response through the wireless communication unit 1004, instructs the wireless communication unit 1004 to transmit job information and a job to be processed by the image forming apparatus 100. Here, the job information includes the number, the names and the image sizes of the jobs to be transmitted hereafter by the communication apparatus 1000 as illustrated in FIG. 8. Further, each job to be transmitted includes the image data stored in the communication apparatus 1000. If all the jobs are transmitted, then the communication apparatus 1000 transmits a communication disconnection request for disconnecting the communication to the image forming apparatus 100, and then disconnects the communication. In this case, the image forming apparatus 100 receives the communication disconnection request, and then performs a necessary process to disconnect the communication.

FIG. 8 is a diagram illustrating an example of the job information to be transmitted from the communication apparatus 1000 to the image forming apparatus 100 respectively illustrated in FIG. 2. In the present embodiment, since the communication apparatus 1000, which has an imaging function, manages the names and the sizes of the imaged and captured image data as associating them with others, the communication apparatus 1000 transmits, as the job information, the names and the sizes of the imaged and captured image data in addition to the job numbers. However, it should be noted that the information to be included in the job information is not limited to those as described above. That is, another information may be included in the job information. In any case, the image forming apparatus 100 stores the received job information in the DRAM 116, and manages the stored job information.

According to the constitution as described above, the image forming apparatus 100 can receive the job from the communication apparatus 1000 which was approximated thereto by the user, and then perform the received jobs in due order. Incidentally, it is possible for the image forming apparatus 100 to adopt a method of receiving the image (i.e., the image data) and the image information from the communication apparatus 1000, managing the received image information in the DRAM 116, holding the received image data as the job in the HDD 260, and performing the held jobs in due order. Consequently, the user can easily transmit the job that the user wishes to cause the image forming apparatus 100 to perform, by approximating the communication apparatus 1000 to the image forming apparatus 100 to which the user wishes to transmit the job. Incidentally, the print job is described as a kind of job in the present embodiment. The image forming apparatus 100 performs the printing of the image data received from the communication apparatus 1000 by performing the job received from the communication apparatus 1000. Here, as print setting in case of the printing, the initial setting of the image forming apparatus 100 may be adopted. Alternatively, the setting which is input through the operation unit 250 before the user approximates the communication apparatus 1000 to the image forming apparatus 100 may be adopted. The image forming apparatus 100 performs the printing of the image data according to the print setting.

Further, as a higher-speed communication method is adopted, it becomes possible to increase transmission speed of the image data. Thus, it becomes possible to transmit in a short period of time the numerous image data as the jobs to be processed by the image forming apparatus. However, there is a case where the user wishes to cancel the transmitted job while the relevant job is being transmitted. In this case, if the conventional method of causing the touch panel section 401 to display the job list through the operation unit 250, selecting from the job list the job transmitted from the communication apparatus 1000, and deleting the selected job is used, it is impossible for the user to cancel the job quickly. For this reason, there is a fear that the job transmitted to the image forming apparatus 100 is performed before the user's instruction to cancel the relevant job is accepted. Consequently, the image forming apparatus according to the present embodiment performs such control as described below so that the user can easily cancel the job transmitted from the communication 1000 with simple operations.

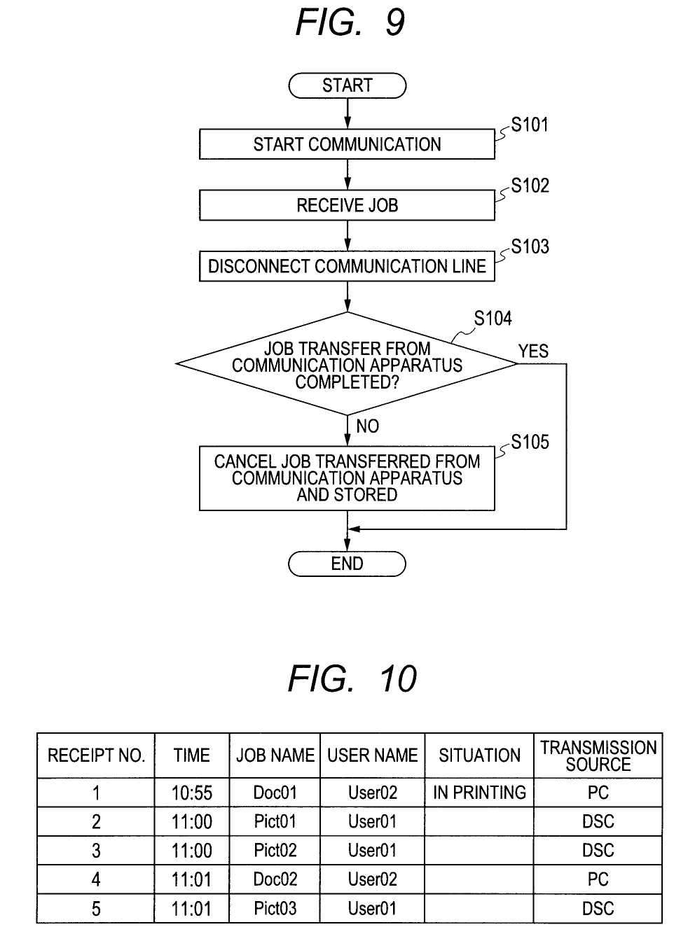

FIG. 9 is a flow chart indicating a job processing procedure of the image forming apparatus 100 according to the present embodiment. More specifically, this procedure corresponds to the process to be performed by the image forming apparatus 100 in case of, if the communication with the communication apparatus 1000 is disconnected, canceling only a predetermined job by referring to the job information previously received from the communication apparatus 1000. Incidentally, illustrated S101, S102, S103, S104 and S105 indicate respective steps, and the processes in the respective steps are performed if the CPU 112 illustrated in FIG. 3 loads the control programs from the ROM 114 and/or the HDD 260 to the DRAM 116 and performs the loaded programs.

Initially, if the communication apparatus 1000 is approximated to the communication unit 10, the image forming apparatus 100 receives the communication request from the communication apparatus 1000, and returns the communication response to the communication apparatus 1000. Thus, the image forming apparatus 100 starts the communication with the communication apparatus 1000 (S101). Then, the image forming apparatus receives the job after receiving the job information from the communication apparatus 1000 (S102). Here, a job situation of the image forming apparatus 100 at this time is illustrated in FIG. 10.

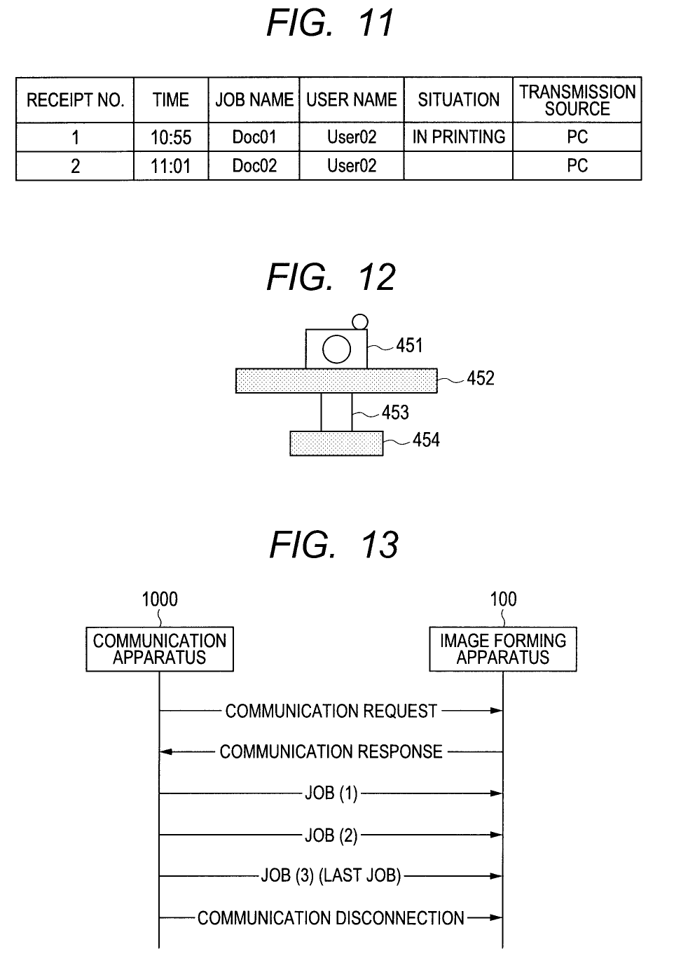

Each of FIGS. 10 and 11 is a diagram illustrating an example of a management table indicating the job situations held in the image forming apparatus 100 illustrated in FIG. 2. This example shows the state that the job information received from the communication apparatus 1000 and the job information received from the PC 4001 are held. In any case, in the present embodiment, a receipt number, a receipt time, a job name, a user name, a situation and a transmission source are managed on the management table for each job.

More specifically, if the job is received, the CPU 112 of the image forming apparatus 100 gives the receipt number to the received job in ascending order, gives the job reception time, the job name and the transmission source to the received job, and stores these data as associating them with others. Here, the CPU 112 only has to give the user name if it can be identified. Namely, the CPU 112 need not give the user name if it cannot be identified. Further, as the transmission source, the CPU 112 only has to use a value such as a product ID or the like of the communication apparatus 1000 by which the communication apparatus 1000 can be uniquely identified. If the PC 4001 or the PC 4002 is used, the CPU 112 only has to use a product ID or a host name of the PC. On the management table illustrated in FIG. 10, the jobs (Pict01, Pict02, Pict03) received from the communication apparatus 1000 and the jobs (Doc01, Doc02) received from the PC 4001 through the network 4000 have been held. Further, the management table illustrated in FIG. 10 indicates that printing of the job having the job name “Doc01” is being performed by the printer unit 300. Incidentally, although the jobs are performed basically in order of acceptance, the user can change the order of performing the jobs through the operation unit 250.

Under the circumstances, if the communication from the communication apparatus 1000 is disconnected (S103), the image forming apparatus 100 causes the CPU 112 to judge whether or not the transfer from the communication apparatus 1000 has been completed, by referring to the job currently received and its job information (S104). Incidentally, as illustrated in FIG. 8, since the job number, the name and the size are managed as job identification information, the CPU 112 can judge that the job transfer is not completed if the size of the job of which the number is, e.g., “3” is smaller than 3 megabytes. Here, if the CPU 112 judges that the job transfer is not completed, the CPU 112 cancels a series of the jobs transferred from the communication apparatus 1000 from the start of the communication to the disconnection of the communication by referring to the job information (S105). Here, the series of the jobs includes the jobs which were received from the communication apparatus 1000 and are indicated by the job information stored in the DRAM 116. More specifically, “Pict01”, “Pict02” and “Pict03” of which the transmission sources are all “DSC” illustrated in FIG. 10 correspond to the series of the jobs, and these jobs are to be canceled. Incidentally, the CPU 112 of the image forming apparatus 100 does not cancel the jobs “Doc01” and “Doc02” other than the jobs “Pict01”, “Pict02” and “Pict03”. Further, in addition to the jobs “Pict01”, “Pict02” and “Pict03”, if there is another job which is transmitted from the same transmission source “DSC” as that of the above jobs but is not transmitted by the same communication (communication session) as that of the above jobs, it is controlled not to cancel the relevant job. Thus, the user can cause the CPU 112 to cancel only the jobs transmitted in the relevant communication session.

Here, a situation that the transfer is not completed occurs in a case where the user who operates the communication apparatus 1000 parts from the image forming apparatus 100 more than an effective distance at which wireless communication can be performed between the communication apparatus 1000 and the wireless communication unit 400 provided in the image forming apparatus 100, a case where the power of the communication apparatus 1000 is turned off, and the like.

The job situation of the image forming apparatus 100 at this time is illustrated in FIGS. 10 and 11. As illustrated in FIG. 11, only the jobs “Pict01”, “Pict02” and “Pict03” received from the communication apparatus 1000 are cancelled, but the jobs “Doc01” and “Doc02” received from the PC 4001 are not canceled.

On the other hand, if it is judged by the CPU 112 in S104 that the transfer has been completed, the process normally ends.

By the control as described above, if the communication between the image forming apparatus 100 and the communication apparatus 1000 is disconnected before it is normally completed, the image forming apparatus 100 can cancel the job received from the communication apparatus 1000 in the relevant communication. Further, even if there are the plural jobs transmitted from the communication apparatus 1000, the user can easily cancel these jobs by performing an operation for distancing the communication apparatus 1000 from the wireless communication unit 400. Furthermore, if the image forming apparatus 100 controls not to cancel the job received in communication other than the communication (communication session), the user can cancel only the jobs received in the relevant communication (communication session) by a simple operation.

Incidentally, in the present embodiment, the CPU 112 judges in S104 whether or not the transfer of the job has been completed, by referring to the job information. However, the present invention is not limited to this. For example, the CPU 112 may judge that the job transfer is not completed in a case where the communication disconnection request illustrated in FIG. 7 is not received.

### Second Embodiment

In the second embodiment of the present invention, the communication unit 10 has a weight detection unit (not illustrated) for detecting a weight of an object (or a body) which is put on the communication unit 10. Namely, the hardware constitution other than the weight detection unit is the same as that described in the first embodiment.

FIG. 12 is a cross section diagram for describing a constitution of the weight detection unit provided in the image forming apparatus 100. In FIG. 12, a setup table 452 on which an object (or a body) 451 is put is supported by a weight sensor 454 through a weight transmission unit 453, whereby the weight of the object 451 is detected by the weight sensor 454. Then, it is judged that the object is put on the setup table if the detected weight is equal to or heavier than a predetermined value. Here, it is assumed that the communication apparatus 1000 is included in the object 451.

FIG. 13 is a diagram illustrating a data communication procedure of the communication apparatus 1000 and the image forming apparatus 100 according to the present embodiment. First, if a user approximates the communication apparatus 1000 to the wireless communication unit 400 of the image forming apparatus, the wireless communication unit 1004 of the communication apparatus 1000 detects a radio wave transmitted from the wireless communication unit 400 of the image forming apparatus 100, whereby the wireless communication unit 1004 detects that the communication apparatus 1000 has been approximated to the wireless communication unit 400. Then, if it is detected that the communication apparatus 1000 has been approximated to the wireless communication unit 400 of the image forming apparatus, the CPU 1001 of the communication apparatus 1000 instructs the wireless communication unit 1004 to transmit a communication request. Subsequently, the wireless communication unit 400 of the image forming apparatus 100, which received the communication request transmitted from the wireless communication unit 1004, returns a communication response. Incidentally, although the wireless communication unit 400 returns the communication response in the present embodiment, the CPU 112 may receive the communication request from the wireless communication unit 400 through the wireless communication I/F 180, and then return the communication response. The CPU 1001, which received the communication response through the wireless communication unit 1004, instructs the wireless communication unit 1004 to transmit a job to be processed by the image forming apparatus 100.

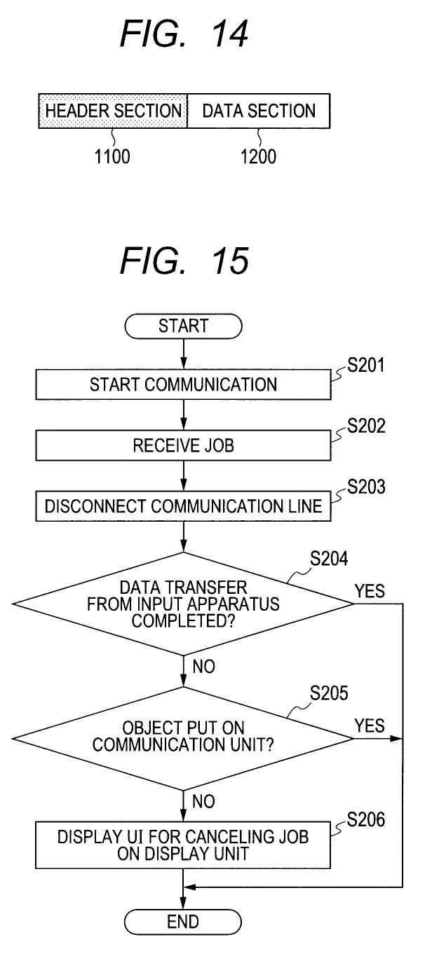

FIG. 14 is a diagram for describing a structure of transfer data to be transferred from the communication apparatus 1000 illustrated in FIG. 1. In FIG. 14, the transfer data from the communication apparatus 1000 includes transfer information which is divided into a header section 1100 and a data section 1200. Here, information indicating whether or not the transfer data is last data has been embedded to the header section 1100 by the communication apparatus 1000. If the transfer of all the jobs is completed, the communication apparatus 1000 disconnects the communication.

FIG. 15 is a flow chart indicating a job processing procedure of the image forming apparatus 100 according to the present embodiment. More specifically, this procedure corresponds to the process to be performed by the image forming apparatus 100 in case of, if the communication from the communication apparatus 1000 is disconnected, canceling only the jobs received by the image forming apparatus 100 after a communication start time with the communication apparatus 1000. In particular, the above procedure corresponds to the process to be performed by the image forming apparatus 100 in case of, if it is judged by the weight detection unit that an object is not put on the communication unit 10, canceling only the jobs received by the image forming apparatus 100 after the communication start time with the communication apparatus 1000. Incidentally, illustrated S201, S202, S203, S204, S205 and S206 indicate respective steps, and the processes in the respective steps are performed if the CPU 112 illustrated in FIG. 3 loads the control programs from the ROM 114 and/or the HDD 260 to the DRAM 116 and performs the loaded programs.

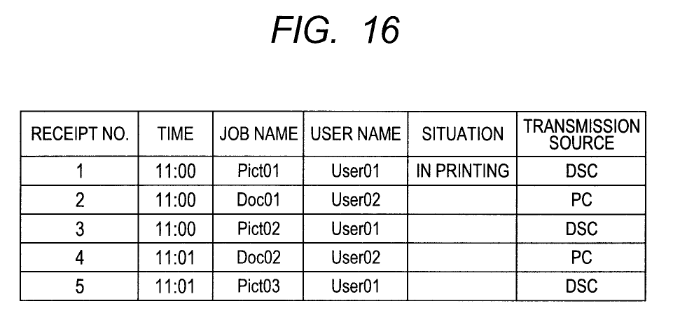

Initially, if the communication apparatus 1000 is approximated to the communication unit 10, the image forming apparatus 100 starts the communication, and the CPU 112 stores the communication start time on the DRAM 116 (S201). Then, the image forming apparatus 100 receives the job wirelessly transmitted from the communication apparatus 1000 (S202). Here, a job situation of the image forming apparatus 100 at this time is illustrated in FIG. 16.

FIG. 16 is a diagram illustrating an example of the management table indicating the job situations held in the image forming apparatus 100 illustrated in FIG. 2. This example shows the state that the image information received from the communication apparatus 1000 and print information received from the PC 4001 are held.

More specifically, in addition to the jobs (Pict01, Pict02, Pict03) received from the communication apparatus 1000, the jobs (Doc01, Doc02) received from the PC 4001 through the network 4000 exist in the image forming apparatus 100. Further, FIG. 16 indicates that printing of the job having the job name “Pict01” is being performed.

Under the circumstances, if the communication from the communication apparatus 1000 is disconnected (S203), the flow advances to S204. Thus, the image forming apparatus 100 causes the CPU 112 to analyze whether or not the transfer data is last data from the header section of the most recently received job, and then causes the CPU 112 to judge whether or not the data transfer from the communication apparatus 1000 has been completed (S204). Here, if it is judged by the CPU 112 that the transfer has been completed, the process normally ends.

On the other hand, if it is judged by the CPU 112 that the data transfer is not completed, it is further judged by the weight detection unit whether or not the object is put on the communication unit 10 (S205). Incidentally, the CPU 112 may judge whether or not the object is put on the communication unit, based on an output from the weight detection unit. Here, if it is judged by the CPU 112 that the object is not put on the communication unit, the flow advances to S206. Then, the CPU 112 causes the display unit 11 to display a user interface for causing the user to select whether or not to cancel all the jobs received from the communication apparatus 1000 after the communication start time, including the currently printed job (S206).

On the other hand, if it is judged by the CPU 112 in S205 that the object is put on the communication unit, the process normally ends.

By the control as described above, on the occasion when the communication between the image forming apparatus 100 and the communication apparatus 1000 is disconnected, it is possible for the image forming apparatus 100 not to cancel the received job if the communication apparatus 1000 is put on the communication unit 10, while it is possible for the image forming apparatus 100 to cause the user to select whether or not to cancel the received job if the communication apparatus 1000 is not put on the communication unit 10. More specifically, the CPU 112 causes the display unit 11 to display the user interface for accepting from the user the instruction as to whether or not to cancel the job indicated by the job information stored in the DRAM 116. Thus, it is possible to cancel the stored job by accepting the user's instruction input to the user interface displayed on the display unit 11. That is, even in a case where the communication between the communication apparatus 1000 and the image forming apparatus 100 is disconnected due to some kind or another communication obstacle in a situation that the user does not intend, the printing of the job already received is performed if the communication apparatus 1000 is put on the communication unit 10.

### Third Embodiment

In the third embodiment of the present invention, a second wireless communication unit 460 (i.e., a not-illustrated second communication unit) which can perform wireless communication of which the effective distance is longer than that of the wireless communication to be performed by the wireless communication unit 400 (i.e., a first communication unit) is provided in the communication unit 10. Here, the hardware constitution other than the second wireless communication unit is the same as that described in the first embodiment.

Incidentally, as an example of the second wireless communication unit 460, there is provided a device wirelessly performing bi-directional communication based on a Bluetooth™ standard, a wireless LAN, or the like. Here, it should be noted that, based on the Bluetooth™ standard, communication can be performed at speed of 1 Mbps by using radio waves of 2.45 GHz band. Unlike an IrDA (infrared Data Association) standard in which infrared rays are used, in a case where a distance between devices which mutually communicate with each other is within 10 m, the Bluetooth™ standard can be used even if there is an obstacle between these devices. Further, in the Bluetooth™ standard, since a small-sized transceiver of 0.5 square inches is used, power consumption is smaller than that in the IrDA standard. Also, manufacturing costs in the Bluetooth™ standard can be suppressed to be lower than those in the IrDA standard.

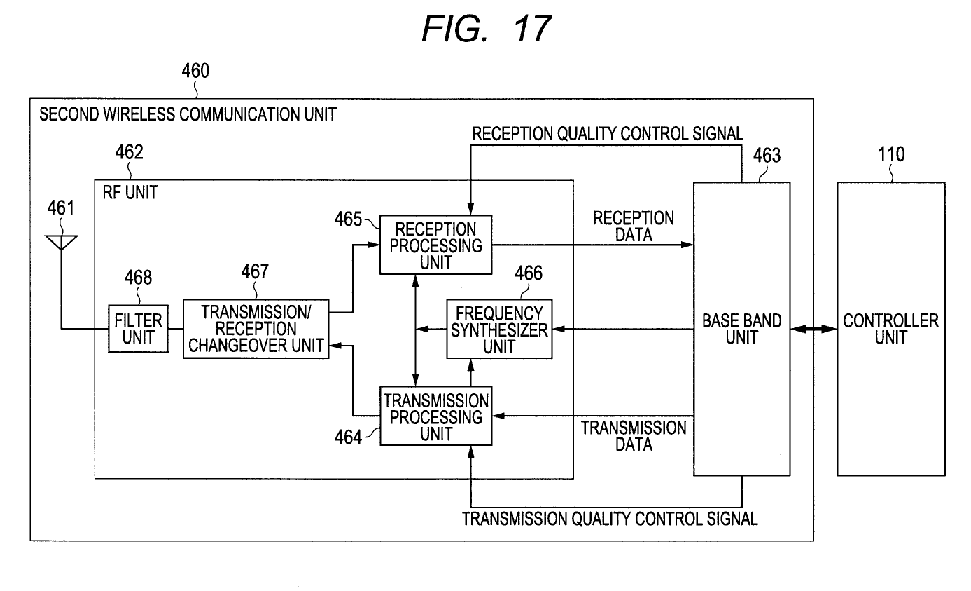

Hereinafter, an example of the second wireless communication unit of the image forming apparatus, which uses the Bluetooth™ standard by way of example, is indicated in FIG. 17.

FIG. 17 is a block diagram for describing a constitution of the second wireless communication unit of the image forming apparatus 100 according to the present embodiment. This example corresponds to a case where the second wireless communication unit 460 bi-directionally performs a data transfer process with the communication apparatus 1000.

In FIG. 17, the second wireless communication unit 460 roughly includes an antenna unit 461, an RF (radio frequency) unit 462, and a base band unit 463. Hereinafter, an outline of each unit will be described. That is, the base band unit 463 transfers/receives data to/from the controller unit 110, and also establishes a communication link for transmitting/receiving data in the wireless communication. At the same time, the base band unit 463 provides various functions such as a packet retransmission function, an error correction function, a function for managing a frequency hopping operation performed by the RF unit 462, and the like. Also, the base band unit 463 transfers a wireless quality control signal to the RF unit 462 in response to an instruction from the controller unit 110. The RF unit 462 includes a transmission processing unit 464, a reception processing unit 465, a frequency synthesizer unit 466, a transmission/reception changeover unit 467, and a filter unit 468. Here, the filter unit 468 filters, among radio waves of various frequencies, the radio waves in the frequency band used in the Bluetooth™ standard. The transmission/reception changeover unit 467 is the switch for performing a changeover between transmission radio waves and reception radio waves. In the Bluetooth™ standard, since the communication between a master and a slave is basically performed by repetition of transmission and reception, the transmission and the reception are not performed simultaneously, whereby the antenna can be shared both in the transmission and the reception. Therefore, such two modes, i.e., a transmission mode and a reception mode, are properly changed over by means of a switch.

The transmission processing unit 464 processes transmission packet data received from the base band unit 463, synthesizes the processed data and a transmission wave generated by the frequency synthesizer unit 466 according to a frequency modulation method, and transmits the obtained data from the antenna unit 461. Further, the transmission processing unit 464 controls power at the time of transmission according to a transmission quality control signal received from the base band unit 463.

Here, the communication channel frequency in the Bluetooth™ standard includes in total frequencies of 79 channels at 1 MHz intervals from 2402 MHz to 2480 MHz. Further, the transmission and the reception are alternated every 625 μsec, and the transmission and reception frequencies are hopped to another channel every time the transmission and the reception are alternated. This is because radio waves for various applications are transmitted and received in the 2.4 GHz band. Namely, since numerous radio waves are exchanged in this band, interference occurs easily. Thus, if the interference occurs in a certain channel, it is necessary to secure the connection by using another channel. The frequency hopping is performed to achieve such an object. Also, the frequency hopping is performed to improve security in the communication.

Incidentally, the transmission frequency is determined based on an oscillation frequency of the frequency synthesizer unit 466. Namely, the oscillation frequency of the frequency synthesizer unit 466 is designated from the base band unit 463 every time the frequency hopping is performed, and the frequency synthesizer unit 466 starts oscillation at a predetermined channel frequency in response to such frequency designation. The reception processing unit 465 receives, from the radio waves of various frequencies reached the antenna unit 461, the signals of the 2.4 GHz band through the filter unit 468. Then, the signal received through the filter unit 468 is input to the reception processing unit 465 through the transmission/reception changeover unit 467.

Here, numerous radio waves from other Bluetooth™ devices and numerous radio waves unrelated to the Bluetooth™ standard exist in the 2.4 GHz band. For this reason, the radio wave of the desired channel frequency is selected in a superheterodyne method of performing frequency conversion to obtain an intermediate frequency (IF), and the data on the received radio wave is extracted. Here, it should be noted that the intermediate frequency in this block is 2 MHz. In any case, if the data is extracted from the received radio wave, the extracted data is restored to a digital signal, and the obtained digital signal is transferred as a received packet data to the base band unit 463. Further, a degree of amplification in regard to the received signal is controlled according to a reception quality control signal received from the base band unit 463.

A communication procedure of the communication apparatus 1000 and the image forming apparatus 100 according to the third embodiment of the present invention is the same as that illustrated in FIG. 13. Further, a unit from the reception of a communication request by the wireless communication unit of the image forming apparatus 100 to the disconnection of the communication after the reception of all jobs is considered as a communication session.

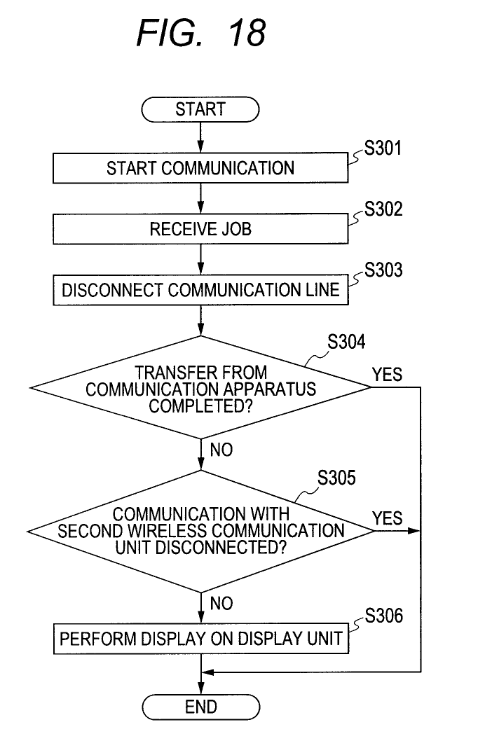

FIG. 18 is a flow chart indicating an example of a job processing procedure of the image forming apparatus according to the present embodiment. More specifically, this procedure corresponds to the process to be performed by the image forming apparatus 100 in case of, if the communication from the communication apparatus 1000 is disconnected, canceling only the jobs received from the communication apparatus 1000 in the same communication session if also the communication by the second wireless communication unit 460 is disconnected. Incidentally, illustrated S301, S302, S303, S304, S305 and S306 indicate respective steps, and the processes in the respective steps are performed if the CPU 112 illustrated in FIG. 3 loads the control programs from the ROM 114 and/or the HDD 260 to the DRAM 116 and performs the loaded programs.

Initially, if the communication apparatus 1000 is approximated to the communication unit 10, the image forming apparatus 100 starts the communication, and stores the communication session (S301). Then, the image forming apparatus 100 receives the job from the communication apparatus 1000 (S302). Here, it is assumed that a job situation of the image forming apparatus 100 at this time is the same as that illustrated in FIG. 8. Under the circumstances, if the communication from the communication apparatus 1000 is disconnected (S303), the image forming apparatus 100 causes the CPU 112 to judge whether or not the transfer from the communication apparatus 1000 has been completed (S304).

Here, if the CPU 112 judges that the transfer has been completed, the process normally ends, whereby the communication session is completed. On the other hand, if the CPU 112 judges that the transfer is not completed, the CPU 112 further judges whether or not the communication by the second wireless communication unit 460 is disconnected (S305). Here, if the CPU 112 judges that the communication is disconnected, then the CPU 112 causes the display unit to perform display for causing the user to select whether or not to cancel the job received from the communication apparatus 1000 in the communication session same as the stored communication session (S306). On the other hand, if the CPU 112 judges that the communication is not disconnected, the process normally ends, whereby the communication session is completed.

By the control as described above, on the occasion when the communication between the image forming apparatus 100 and the communication apparatus 1000 is disconnected, it is possible for the image forming apparatus 100 not to cancel the received job if the communication apparatus 1000 exists in the vicinity of the communication unit 10, while it is possible for the image forming apparatus 100 to cause the user to select whether or not to cancel the received job if the communication apparatus 1000 does not exist in the vicinity of the communication unit 10. That is, even in a case where the communication from the communication apparatus 1000 is disconnected in a situation that the user does not intend, the printing of the job already received is performed if the communication apparatus 1000 has been set in the vicinity of the communication unit 10. Incidentally, if the output of the second wireless communication unit 460 is controlled so that the communicable range thereof is set to, for example, 15 cm or so, the CPU 112 can judge whether or not the user intentionally disconnected the communication.

Incidentally, in the first embodiment, the CPU 112 cancels in S105 the job without displaying such a screen as disclosed in the second and third embodiments for accepting the instruction as to whether or not to cancel the job from the user. However, the CPU 112 may display the screen for accepting the instruction whether or not to cancel the job from the user, so as to confirm the user whether or not to cancel the job. Then, the CPU 112 may cancel the job after actually receiving the instruction for canceling the job from the user. On the other hand, in S206 of the second embodiment and S306 of the third embodiment, the CPU may cancel the job without displaying the screen for accepting the instruction as to whether or not to cancel the job from the user.

Further, in the first embodiment, the CPU 112 of the image forming apparatus 100 does not cancel the jobs “Doc01” and “Doc02” of which the transmission source is different from that of the jobs “Pict01”, “Pict02” and “Pict03”. Furthermore, if there is the job other than the jobs “Pict01”, “Pict02” and “Pict03” which is transmitted from the same transmission source “DSC” as that of these jobs but is not transmitted by the same communication (communication session) as that of these jobs, it is controlled not to cancel the relevant job. However, the jobs to be canceled are not limited to those described in the above examples. That is, if there is another job of which the transmission source is the same as that of the jobs “Pict01”, “Pict02” and “Pict03”, also this job may be canceled together. More specifically, in a case where the communication from the communication apparatus 1000 is disconnected before the reception of the image from the communication apparatus 1000 is not completed, the CPU 112 of the image forming apparatus 100 controls to cancel all the jobs which are managed based on the same product ID as the product ID of the communication apparatus with which the image forming apparatus 100 performed the communication. Such control is also applicable to the jobs to be canceled in the second and third embodiments.

Further, in the above-described embodiments, the print job of causing the printer unit 300 to print the image data received by the image forming apparatus 100 is processed. However, this process is also applicable to the transmission job of transmitting the image data and/or the store job of storing the image data in the HDD 260. In the transmission job, the job being transmitted and the job waiting for the transmission may be canceled. Further, in the store job, the job already stored in the HDD 260, the job being stored, and the job waiting for the storing may be canceled.

While the present invention has been described with reference to what is presently considered to be the preferred embodiment, it is to be understood that the invention is not limited to the disclosed embodiment. On the contrary, the present invention is intended to cover various modifications and equivalent arrangements (including the organic combination of respective embodiments) included within the spirit and scope of the appended claims. The scope of the following claims is to be accorded the broadest interpretation so as to encompass all such modifications and equivalent structures and functions.

### Other Embodiments

Aspects of the present invention can also be realized by a computer of a system or an apparatus (or a device such as a CPU or an MPU) that reads out and executes a program recorded on a memory device to perform the functions of the above-described embodiments, and by a method, the steps of which are performed by a computer of a system or an apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-146383, filed Jun. 19, 2009, which is hereby incorporated by reference herein in its entirety.

What is claimed is:

1. A job processing apparatus for establishing a communication session with a communication apparatus and communicating with the communication apparatus by the established communication session, comprising:
a receiving unit configured to receive plural images from the communication apparatus by the communication session;
a holding unit configured to hold the plural images received by the receiving unit, as plural jobs to be processed; and
a control unit configured to, in a case where the communication session with the communication apparatus is disconnected while the reception of the plural images is not completed, cancel, among the jobs held in the holding unit, the job corresponding to the image which has been received from the communication apparatus by the communication session.

2. A job processing apparatus according to claim 1, further comprising an accepting unit configured to accept a communication request from the communication apparatus,
wherein the control unit establishes the communication session according to the acceptance of the communication request, and
in the case where the communication session with the communication apparatus is disconnected while the reception of the plural images is not completed, the control unit cancels the job corresponding to the image which has been received from the communication apparatus by the communication session during a period from the acceptance of the communication request by the accepting unit to the disconnection of the communication session.

3. A job processing apparatus according to claim 1, wherein
the control unit displays a screen to be used for a user to instruct whether or not to cancel the job corresponding to the image which has been received from the communication apparatus, and
in a case where it is instructed by the user to cancel the job, the control unit cancels the job corresponding to the image which has been received from the communication apparatus by the communication session.

4. A job processing apparatus according to claim 1, further comprising an input unit configured to input, from the communication apparatus, information of the plural images received by the receiving unit,
wherein the control unit detects whether or not the reception of the plural images has been completed, based on the information input by the input unit.

5. A job processing apparatus according to claim 1, further comprising:
a first communication unit through which the job processing apparatus communicates with the communication apparatus; and
a second communication unit through which the job processing apparatus communicates with the communication apparatus,
wherein, in a case where the communication with the communication apparatus through the first communication unit is disconnected, if the communication with the communication apparatus through the second communication unit is not disconnected, the control unit controls not to cancel the job corresponding to the image which has been received from the communication apparatus by the communication session even if the reception of the plural images is not completed.

6. A job processing apparatus according to claim 1, wherein the communication apparatus includes any one of a digital camera, a PDA (personal digital assistant), a mobile phone and a memory card.

7. A control method for controlling a job processing apparatus for establishing a communication session with a communication apparatus and communicating with the communication apparatus by the established communication session, the control method comprising:
receiving plural images from the communication apparatus by the communication session;
holding, in a holding unit, the received plural images as plural jobs to be processed; and
controlling to, in a case where the communication session with the communication apparatus is disconnected while the reception of the plural images is not completed, cancel, among the jobs held in the holding unit, the job corresponding to the image which has been received from the communication apparatus by the communication session.

8. A computer readable storage medium for storing a computer executable program for controlling a job processing apparatus for establishing a communication session with a communication apparatus and communicating with the communication apparatus by the established communication session, the computer executable program comprising:
a code to receive plural images from the communication apparatus by the communication session;
a code to hold, in a holding unit, the received plural images as plural jobs to be processed; and
a code to control to, in a case where the communication session with the communication apparatus is disconnected while the reception of the plural images is not completed, cancel, among the jobs held in the holding unit, the job corresponding to the image which has been received from the communication apparatus by the communication session.
